(19) United States
(12) Patent Application Publication
(10) Pub. No.: US 2022/0020396 A1
(43) Pub. Date: Jan. 20, 2022

(54) VIDEO RECORDING AND EDITING SYSTEM

(71) Applicant: HiPoint Technology Services, Inc., Chicago, IL (US)

(72) Inventor: Masud Khan, Chicago, IL (US)

(21) Appl. No.: 17/379,572

(22) Filed: Jul. 19, 2021

Related U.S. Application Data
(60) Provisional application No. 63/053,291, filed on Jul. 17, 2020.

(51) Int. Cl. G11B 27/34; G06N 20/00; H04N 5/765; G11B 27/30

(52) U.S. Cl. CPC G11B 27/34; G11B 27/3036; H04N 5/765; G06N 20/00

(57) ABSTRACT

A video recording system includes a camera sensor, a controller in communication with the camera sensor, and a memory in communication with the controller. The memory includes a video recording application that causes the controller to: store video from the camera sensor; receive a user input to associate an enhanced time marker in the video, and generate a video clip from a subset of the stored video. The video clip begins at a video frame associated with a start time point and ends at a video frame associated with an end time point, and the start and end time points are dependent on the time point associated with the enhanced time marker.

### CROSS-REFERENCE TO RELATED APPLICATIONS

This application claims the benefit of priority to U.S. Provisional Application No. 63/053,291 filed on Jul. 17, 2020, the disclosure of which is incorporated herein by reference.

### BACKGROUND OF THE INVENTION

The present subject matter relates generally to a video and photo recording and editing system and method. More specifically, the present invention relates to a video recording and editing system that enables users to benefit from an enhanced method for capturing and generating videos with the use of enhanced time markers. This enhanced method can be applied to users recording video via the traditional method, where a user starts and stops recording by tapping the record button and stop button respectively, as well as via an enhanced method where the recording device is constantly recording in the background to a circular buffer arrangement that could be permanent or temporary. In both cases enhanced time markers can be used to generate both real and virtual video files to correspond with the wants and desires of the user.

When used with a traditional recording method, these enhanced time markers can be captured during the recording process to specify special time periods within the video, and then later be used to generate virtual or real videos that correspond to those time markers. When used with an enhanced recording method that is constantly recording to a permanent or temporary buffer arrangement, the starting and stopping of recording in this case simply adds a start time marker and end time marker, which can then be used to generate a video from the captured video in the circular buffer arrangement. This enhanced recording method that is constantly recording in the background with time markers also gives users the ability to set a start time before they actually provide any input, as well as set an end time after they provided input to stop recording.

When someone records a video, typically more video is captured than is actually wanted or needed. This is a result of basic limitations on how the video recording process works. As an example of one of these limitations, a user may be observing their child's soccer game and decides that they wish to record a video of their child playing the game; more specifically they want to record the child doing something memorable (e.g., the child kicking a ball, making nice defensive play, or scoring a goal). In hopes of catching such a notable event on video, the user must start recording before the event occurs and keep recording until after such an event takes place. The result of this process is that the user may have recorded several minutes of video to capture a much shorter moment. These large video files, containing minutes of uninteresting footage, may take up a good deal of space on a storage medium and since every computing device, rather it be a camera, smartphone, tablet, personal computer, or other computing device, even with the help of cloud storage, has a finite amount of memory; eventually the storage of extraneous recorded video will limit the functionality of the video recording device.

Another limitation of the traditional video recording process is that the larger video files are much more difficult (if not impossible) to conveniently share via email, social media, or other video sharing methods. Most mediums for sharing a video file have limits on the size of file that may be uploaded and sent. Additionally, most mediums for sharing files also have limits on the size of file that can be received by a user and the total amount of storage space available to a user to store such files. In today's social media driven world, the need to substantially edit a video file down to an appropriate size before sending or posting online is inconvenient and a hindrance to the pace at which news and other important events are shared with the world.

Matching closely with the size limitations of the traditional video recording process, larger video files typically contain longer videos with a good deal of uninteresting content. This means there is also a limitation on the traditional video recording process that requires the use of cumbersome editing software (to extract unwanted portions, apply effects like slow-motion, and/or add music, etc.) to create a video relevant in today's fast paced world.

Editing video files is also cumbersome due to the time it takes for a video editing system to create the new video based on the specified edits (e.g. trim, cut out segments, apply special effects, etc.). Also, the creation of new versions of an original source file creates a new file that takes up space on the user device. For example, if a user takes a ten minute video, and then creates three new versions from this video, one containing the first three minutes, then second containing the next four minutes, and the final containing the last three minutes, then the user now has four files, the original source video which is ten minutes long, and three derived versions taking sections from this video, totaling in this case ten more minutes of video. This method takes up valuable space on the user device, and is cumbersome due to the time it takes for the user device to process and generate the new video file versions.

All of these limitations stem from the biggest issue with traditional video recording and editing methods: that all such devices create and present video files that are tied to this input, and modify such video files per the specified edits that the user makes. Such a method does not allow users to go back in time and get missed video, nor does it allow for the quick creation of alternate versions without a user having to create new files for each such version.

Another common limitation is that video editing UI's (user interfaces) are cumbersome and intimidating, and often require a steep learning curve. Consequently the typical user does little to no editing of video.

Accordingly, there is a need for a user-friendly video recording and editing system that dissociates perception from reality, giving users more flexibility to capture and edit desired video. Such a system could easily capture events prior to a user's input and generate modified and alternate virtual video versions from the captured source files almost instantly without having the need to generate new files each time.

### BRIEF SUMMARY OF THE INVENTION

To meet the needs described above and others, the present invention provides a video recording system that enables the user to generate a video clip of an event, where part or all of the event occurs, or can occur, before the user provides user input that triggers the generation of the video clip. More specifically, the video recording system permits users to retroactively create a video clip of a past event or of an event that contains some part in the past. The video recording system may be embodied in a video recording mobile application that may be run on mobile devices (such as iOS, Android, and Windows Mobile devices), personal computers, and digital cameras (such as those produced by Nikon and GoPro). The video recording system may also be integrated into the device's native recording software.

In such a system, a user could apply a time marker(s) to a video file, the system would generate a video clip having start and end time points associated with the time marker(s). In one example embodiment, the video recording system enables the user to record video directly to the user device's internal memory or stored in temporary file storage arrangement, as described in greater detail below. In both cases, the user views the live video feed through a user interface or points the recording device in the direction of the event to be recorded. While the system is recording video to the internal memory via the traditional method or recording video to a temporary file storage arrangement, the user interface also allows the user to provide user input that applies time marker(s) to the video at the time that the user input(s) is received. The user input could also be provided via an external device such as a smart watch. The user input may be a swipe on the screen, the tapping of a record button, the selection of an enhanced time marker button, a tap on a smartwatch connected to the device, a voice command, or an automated outcome based on settings that are adjusted or set using artificial intelligence, such as correlating a threshold level of movement or noise with an event. The enhanced time marker is associated with a time point or time points on the video at which the user provided the user input.

The video recording system then generates a video clip derived from the captured video and based on the time associated with the enhanced time marker. In other words, video is generated by combining the captured video with information associated with or derived from the enhanced time marker(s). The video clip can be the entire captured video or a subset of the video, and the start and end time points of the video clip are determined based upon information contained within or settings associated with the enhanced time markers. For example, the settings associated with a particular enhanced time marker of the system may define the start time point of the video clip as 10 seconds before the application of an enhanced time marker to a video marking a time point of the enhanced time marker, and the end time point of the video clip is 15 seconds after the same time point of the enhanced time marker, and that the input of that single time point of the enhanced time marker may be obtained by a single user input.

In an illustrative example, a parent may use this feature when recording their child playing in a soccer game. With the video recording system installed on the parent's smartphone, the parent holds their mobile device with the device's camera able to view the on-field action. The user interface of the mobile device running the application will show what is being recorded (either by initiation of a recording event on the device's internal memory via the traditional method or within an always-on, continuously recording method incorporating a temporary file storage arrangement). Just after the parent's child scores a goal, the parent can provide a user input, for example a swipe on the screen or to press a record button which in reality is an enhanced time marker button (or provide another user input), which applies a time marker to the video, thereby generating information that will become a key part of an enhanced time marker to the video. The video recording system, taking into account the captured time point combined with additional information associated with the enhanced time marker, then generates a video clip with the start time point being 10 seconds before the parent swiped the screen and the end time point being 15 seconds after the parent swiped the screen. In a slight variation in this example, the enhanced time marker can contain, in addition to the start and end point of the video, a desired special effect to be applied such as a slow motion effect, in which case the generated video will automatically have that effect applied.

The video clip may be saved onto the device's internal memory as a real video clip or as a virtual video clip in the first instance (as this virtual video file may be converted into a real video file in the next instance) that is generated by combining the information stored in the enhanced time marker with the captured video, whether that video was captured via a traditional recording method into the internal memory of the device or captured into a temporary file storage arrangement. This allows the parent to essentially go “back in time” or “into the future” and capture portions of a moment of the play that they would have otherwise missed. Throughout the game, the parent may use the enhanced time marker features to create a number of video clips of notable events. The parent can also easily manipulate the start time and end time of their video clips by simply adjusting the start time and end time associated with the enhanced time marker before deciding to convert a virtual video file into a real video file, thereby making possible the ability to edit and preview the video without the system first having to process and create a new video file. By using the video recording system, the parent can avoid recording the game in its entirety and create short videos of the notable events by editing and re-editing the original long file.

In one embodiment of the video recording system, the system may feature a file storage arrangement that utilizes temporary files to store video captured by a device's camera while the system is running on the device. This file storage arrangement may function similarly to a circular video buffer: a first in, first out (FIFO) file storage arrangement. Such an arrangement may record pre-defined intervals of video and then eventually write over these pre-defined intervals of video with new intervals of video as time elapses and more video is recorded by the system. In other embodiments, the file storage arrangement may store video up to a certain storage amount, and progressively delete the oldest content as the storage limit is reached. In still further embodiments, the file storage arrangement may delete the content after a certain period of time. In all embodiments, this series of pre-defined video intervals, that are constantly being recorded by the system while the mobile application is running, allows the system to capture moments of video before the user actually presses the record button.

In this embodiment, the system may then discard the unused video that was actively recorded by the user and stored in temporary files, keeping only the desired generated video clips. Alternatively, the user can save a virtual version of the file that would virtually save the file with the use of time markers, which would be reflected during video playback with the use of a custom video player that could interpret and use the source video file(s) and time marker information to present a the virtual video clip in a manner similar to how a real video clip would be presented.

In another embodiment, the video recording system may include a network of user devices composed of recorders and controllers. Each recorder device is capturing a respective video feed, either in a traditional permanent file storage arrangement or in a temporary file storage arrangement, captured in whole or in fragments, and may have a user interface through which the captured video feed can be viewed. Each controller device can then apply enhanced time markers to one or more of the video feeds. Some devices may serve as both a recorder and controller device. For example, a network of four recorder devices, recorders 1 through 4, may be positioned about a basketball court to record a game. The first and second recorder devices may capture first and second views (i.e., videos) near the first basketball hoop, and third and fourth recorder devices may capture third and fourth views (i.e., videos) near the second basketball hoop. Participants (e.g. coaches, audience members) throughout the game, with the use of controller devices (e.g. controller application on their device), can apply enhanced time markers to each of the video feeds as desired. For instance, where a player is making a layup at the second basketball hoop, enhanced time markers can be applied to the video feeds of the third and fourth videos to capture the play from two different perspectives.

In yet another embodiment, an audience member can record video in a traditional manner from their vantage point using their user device. After completing their recording the system can automatically generate an enhanced time marker that corresponds with the start time and end time of the captured video, and then subsequently request the necessary source video from the first through fourth recorder devices in order to collect additional, fully synched videos from additional vantage points provided by the available recorder devices. It should be noted that in one potential embodiment the application of an enhanced time marker may be initiated via the user interface in a most familiar manner by what appears to the user as a traditional record and stop recording button. In yet another iteration, an enhanced time marker may be applied by a button that's labeled “capture past 30 seconds of video”. In one embodiment, to ensure optimal performance of the system, an initialization event of all participating devices, both recorders and controllers, should take place to synch the clocks of all devices to ensure correct association of time markers associated with enhanced time markers are correctly associated with the correct video segments of source video file(s).

The method of applying enhanced time markers by a user using a controller application could include, but not be limited to, the use of a special record button, a swipe gesture, predefined setting combined with artificial intelligence, verbal command, or receiving input via an accessory such as a smart watch. The video recording system can then use the enhanced time marker information and captured video footage to generate and transfer the desired video files directly to the controller devices (e.g. participants) or transfer the necessary video fragments to the controller device(s) that correspond to the enhanced time markers so that the controller device, or some other designated device, can generate the desired video. The system could transfer extra video footage before and after the designated start and end time points contained within the enhanced time marker(s), that could then be used to easily alter the start and end time points.

The capture of source video, all or parts of which are then transferred to a controller (a single device being able to serve in both capacities), in combination with an enhanced time marker would result in the creation of a video clip. Stated more simply, a video clip is created each time an enhanced time marker is applied to a video system or feed. The enhanced time markers may also be manually or automatically tagged with a player's name or a type of play, such as an interception or layup. After the game has ended, the generated video clips, real or virtual, can be reviewed by the team. The coach can retrieve video clips by a number of filters, some examples of which could be user recorder device (i.e., all video clips from the video of the third recorder device), by player name (all video clips tagged “Curry” or “James”), or by type of play (all video clips labeled “interception” or “layup”). In some embodiments, the video recording system may automatically generate a video collage of video clips strung together. In yet another embodiment, after the controller application designates or initiates a capture of a desired time period, the video recording system can immediately present that designated desirable event to a player screen for almost immediate review.

In a network-based multiuser recording system, in which many recorders and controllers can exist, the ability to reduce load on recorder devices and distribute video processing load is valuable. In one embodiment, the recorder devices can capture the video feed in fragments of predefined or dynamically calculated lengths via successive stop recording and start recording events (to subsequently be called “stop start events”), which then can be served to controller applications on controller devices over the network. When a controller device applies an enhanced time marker, the video recording system can determine what file segments would be needed to fulfill the requirements of the enhanced time marker, and then request those files from the relevant recorder devices.

Once the file fragment(s) are received by the controller device, the controller can present the desired video in virtual form by use of the file fragment(s), time marker information, and a specialized video player. The user can easily alter the desired start point and end point associated with the enhanced time marker and preview their desired video in virtual form, and if so desired convert the file from a virtual video to a real video, all the processing of which would take place on the controller device (not the recorder device). Alternatively, once the file fragment(s) are received by the controller device, the controller device can automatically generate the desired video with the use of the enhanced time marker(s) and source video fragment(s), the processing of which would take place on the controller device.

An additional advantage of this system is the ability of the recorder device(s) to make available and deliver the desired video to controller device(s) per the user specified enhanced time marker(s) in an expedient manner, since most recording systems do not allow access to (or are able to serve) live video being streamed and saved into internal memory until recording is stopped and a video file is created. This would result in a highly undesirable situation where the time gap between a user specifying an enhanced time marker and receiving the relevant video file(s) would be very long.

An additional problem that would arise is the significantly increased processing load on the recorder device(s) resulting from the need to first generate new files based on requested video (per the related enhanced time marker) before being able to serve them to controller devices, which in turn would significantly limit the scalability of such a system. By fragmenting the captured video feed into multiple files, one method being the use of successive stop start events, the system effectively makes necessary source files available to controllers in a timely manner and offloads the vast majority of video processing needed to generated desired videos to the controller devices, resulting in a highly scalable system. In one example embodiment, the recorder device(s) can be set to initiate stop start events every 30 seconds, resulting in 30 second video file segments. Once a controller device specifies an enhanced time marker and sends a request to the recorder device(s), the recorder device(s) serve the relevant file segment(s) to the controller device. Once received, the controller device can use those file segments, in combination with the enhanced time marker, to generate the desired video file.

In one embodiment, a video recording system comprises a camera sensor, a controller in communication with the camera sensor, and a memory in communication with the controller. The memory including a video recording application that, when executed by the controller, cause the controller to: store video from the camera sensor; receive a user input to associate an enhanced time marker in the video; and generate a video clip from a subset of the stored video. The video clip begins at a video frame associated with a start time point and ends at a video frame associated with an end time point, and the start and end time points are dependent on the time point associated with the enhanced time marker.

In some embodiments, the step of storing video from the camera sensor comprises the step of continuously storing video in a temporary or permanent file storage arrangement from the camera sensor. In other embodiments, the step of storing video from the camera sensor comprises the step of storing video on an internal memory of the user device.

In other embodiments, the controller receives a plurality of user inputs to associate a plurality of enhanced time markers in the video, each user input associating a respective enhanced time marker, and wherein the controller is configured to generate a plurality of video clips from the subset of stored video.

In some embodiments, the controller receives a first user input and a second user input associated with a first enhanced time marker and a second enhanced time marker, respectively, and wherein the video clip begins at a video frame associated with a start time point dependent on the time point associated with the first enhanced time marker and ends at a video frame associated with an end time point, wherein the end time point dependent on the time point associated with the second enhanced time marker.

An object of the present invention is to address the issue of traditional video recording systems requiring a lot of editing to remove uneventful footage from an event. There is no known way to actually reverse time, so if a user wishes to capture an interesting moment they must record the entire duration of a given event. Typically, memorable events will occur during an organized event (e.g., soccer game, wedding, first communion, etc.) but these events may span hours with only a few moments being interesting (e.g., a child scoring a goal). Traditional recording would require a user to record most, if not all of these events to capture every possible moment in which a memorable event could occur resulting in enormous video files. The video recording system described herein allows instead for a notable event to occur while the user watches passively and gives them the ability to still capture the event if they so choose via an automated recording system constantly running in the background of the application. In some embodiments, storage space on a user's device may be preserved by a circular buffer arrangement wherein video beyond a certain length, or beyond a certain storage percentage, will automatically be deleted.

An advantage of the invention is that, in many cases, it circumvents the need to shorten the length of a video. The present system allows users to create video clips containing minimal to no superfluous video at the time the event is actually happening. This allows the user to more quickly share the information with others and more accurately report on what occurred.

Yet another advantage of the invention is that it saves space on a user's device. By utilizing a more efficient manner of recording video clips and the deletion of unused portions of said clips, a user can save as much as ninety percent of storage space that would be used on their devices if they were to use the standard recording methods.

Yet another advantage of the invention is that the user can create alternate virtual versions of the original clip (source clip) with the user of time markers, without having to create new video files, thereby saving significant space and eliminated processing time.

Still yet another advantage of the invention is that it makes for more easily shareable clips. The ability to easily make smaller clips, whether real or virtual, resulting from the presence of this video recording system, results in a user having clips that can be more easily shared on social media and via email than larger, unedited video files. In some embodiments, virtual clips (as an outcome of user specified time markers) combined with source files contained on a users device or in the cloud, would generate temporary files to be shared, and then after a designated time period be automatically deleted. The preservation of the original source file(s) and time markers would allow for the easy regeneration of the video if so desired.

Another advantage of the invention is that it easily allows for sharing of video files among a network of devices and the immediate editing of source video files to video clips while using only the space necessary for the video clips instead of the full video files. In one application, when combined with cloud storage, video clips can be created from source video files in a collaborative manner by simply the exchange of enhanced time marker information that can include, beyond the start point and end point of the video, time periods of special effects.

A further advantage of the invention is that it reduces clutter in a user's video library. By eliminating the need to start/stop recording in hopes of capturing a worthwhile event, the user will have far fewer unwanted video clips in their video library. This smaller amount of clips saves space, but also reduces overall clutter in a video library, making finding meaningful clips much easier. Clutter would also be reduced by the grouping of virtual and real versions of files with their source file.

And yet a further advantage of the invention is the ability to provide remote recording capabilities over a network that can capture current, past, and future video from multiple sources in a highly scalable manner, thereby significantly enhancing peoples ability to participate and capture desired video(s) at events.

Another advantage of the invention would be the ability of users at events to gain additional vantage points of video that they record on their device which can by fully synched with the video they captured locally on their device.

Another advantage of the invention would be the ability of coaches to be able to easily create review video for their teams by being able to capture educational plays after such plays happen in real time versus having to scour hours of video after the event is over.

And yet another advantage of the invention would be the ability of coaches or teachers, such as theater teachers, to dynamically generate an instant replay of the past to review with players or actors in the moment, thereby significantly enhancing the teaching capabilities of the instructors.

And yet another advantage of the invention would be the ability of family members at graduation events to be able to take pictures and videos from their vantage point and then be able to request and receive pictures and videos from other vantage points setup by the school.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A is a screen illustrating a video recording system embodied as a standalone application on a user device.

FIG. 1B is a schematic diagram illustrating an example of a standalone video recording application running on a user device.

FIG. 2A is a screen illustrating the graphical user interface of the video recording system running on a user device.

FIG. 2B is a screen illustrating the graphical user interface of the video recording system recording a video.

FIG. 3 is a diagram of a temporary file storage arrangement based on an enhanced time marker.

FIG. 4 is a user interface of the settings menu for defining the start and end time points relative to a time associated with an enhanced time marker.

FIG. 5A is a screen illustrating a media gallery of the video recording system.

FIG. 5B is a screen illustrating the video recording system's functionality for merging video files.

FIG. 5C is a social media sharing screen of the media gallery illustrating the social media sharing feature.

FIG. 5D is a social media sharing screen of the media gallery illustrating virtual files.

FIG. 6 is a screen illustrating an editing user interface of the video recording system.

FIG. 7 is a diagram of a temporary file storage arrangement.

FIG. 8A is a screen illustrating the edit video interface of the video recording system permitting the user to edit the desired starting point of the video.

FIG. 8B is a screen illustrating the edit video interface of the video recording system permitting the user to edit the desired endpoint of the video file.

FIG. 9A is a screen illustrating the trimming interface of the video recording system to edit the starting point of the section to be trimmed.

FIG. 9B is a screen illustrating the trimming interface of the video recording system to edit the endpoint of the section to be trimmed.

FIG. 10A is a screen illustrating the special effects interface of the video recording system adding a starting point of a special effect to a video file.

FIG. 10B is a screen illustrating the special effects interface of the video recording system setting an endpoint of a special effect.

FIG. 11A is a screen illustrating the sharing and settings menu.

FIG. 11B is a screen illustrating the sharing options displayed by the sharing and settings menu.

FIG. 12 is a schematic diagram of a further embodiment of a video recording system including a network of devices.

FIG. 13 is a user interface illustrated the video feeds of the network of devices of FIG. 11.

### DETAILED DESCRIPTION OF THE DRAWINGS

The present application provides a video recording system 10 that enables the user to generate a video clip of an event, where the event occurs before the user provides user input that triggers the generation of the video clip. More specifically, the video recording system 10 permits users to retroactively create a video clip of a past event. The video recording system may be embodied in a video recording mobile application that may be run on mobile devices (such as iOS, Android, and Windows Mobile devices), personal computers, digital cameras (such as those produced by Nikon and GoPro), and other devices (such as Google Glass and Apple Watch). The video recording system may also be integrated into the device's native recording software.

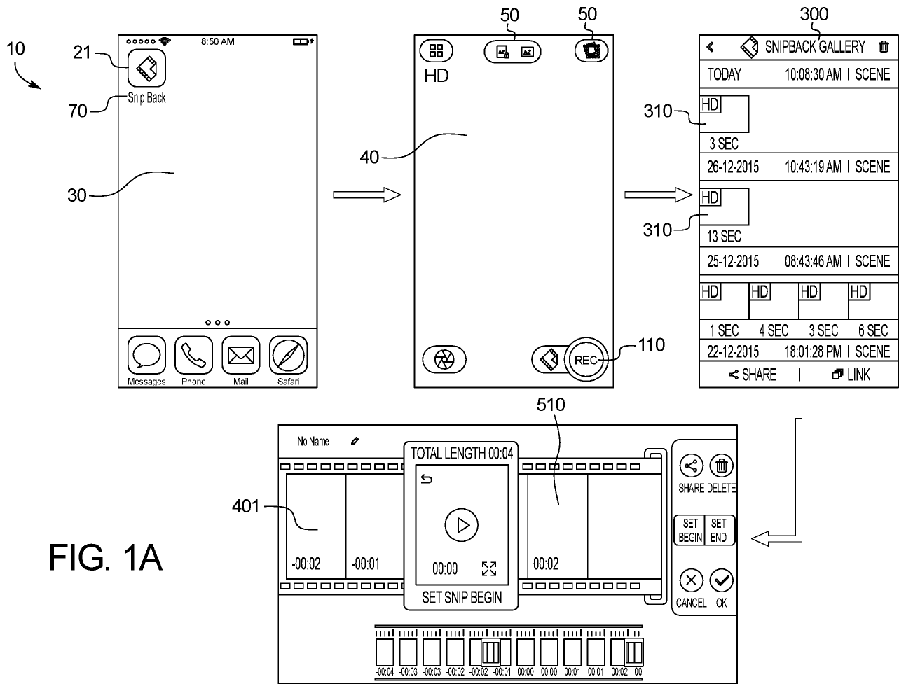

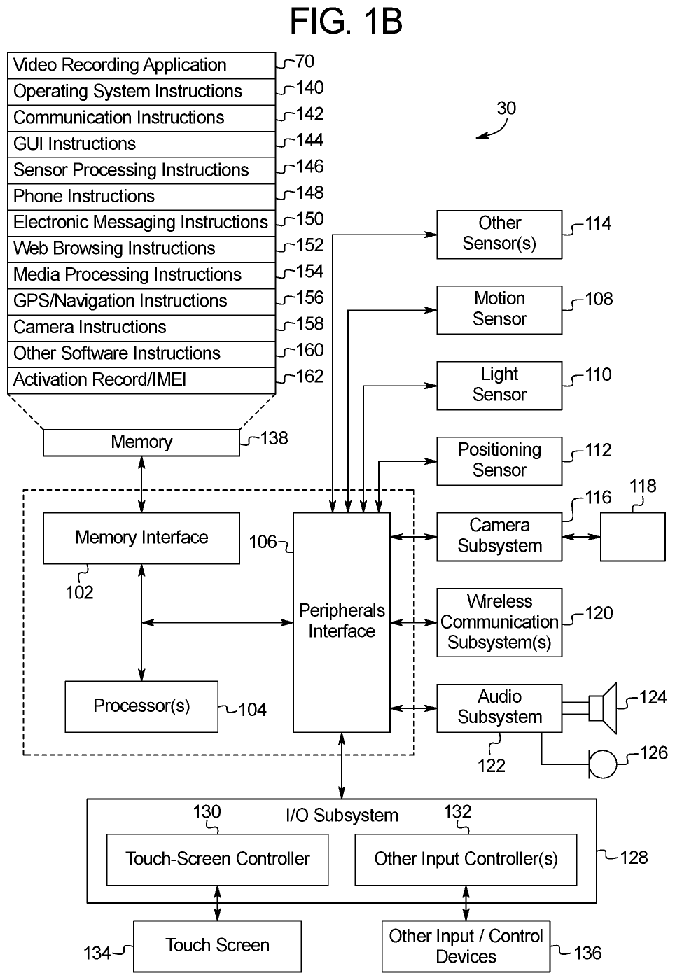

FIG. 1A is a series of screens illustrating a video recording system 10 embodied as a standalone application 70 on a user device 30. As shown in FIG. 1A, a video recording system 10 may exist as a standalone application 70 on a user device 30 (e.g., smartphone, tablet, personal computer, digital camera, or other computing device). To launch the application 70, a user may only need to tap the application's touchscreen icon 21 in the same manner used to launch most smartphone applications. Once the application 70 is opened, the user device 30 may display the video recording system's 10 graphical user interface (GUI) 40. This GUI 40 may feature touchscreen controls 110 that allow a user to select when they would like to begin recording video 510.

In some embodiments, the recording is saved on the device's internal memory and is initiated via the traditional method of selecting the record button to start and stop the video. In other embodiments, the recording is continuous using the temporary file storage arrangement as discussed below. In still further embodiments, the video recorded may include a recorded video file that is saved to the device's internal memory and a temporary video file that is stored in the temporary file storage arrangements. In the embodiment illustrated in FIG. 1A, once a video 510 is recorded, it may be saved as a video file 310 in the user device's 30 memory 138 and accessible via the system's 10 media gallery 300. When a video file 310 is saved, it may then be accessed in the gallery 300. The file 310 may include both recorded video 510 and temporary video 401. The temporary video 401 may represent video 401 captured before a user pressed the touchscreen record button 110, allowing the user to save a video file 310 that captures moments that would have been otherwise missed.

FIG. 1B is a schematic diagram illustrating an example a standalone video recording application 70 running on a user device 30. As shown in FIG. 1B, the user device 30 may be a mobile device, such as a smartphone, running a standalone video recording application 70 to provide the functionality described herein. A user may install the video recording application 70 on his or her user device 30 and launch it via touchscreen icon 21. The user device 30 may include wireless communication subsystem 120 to communicate with one or more media sharing mediums.

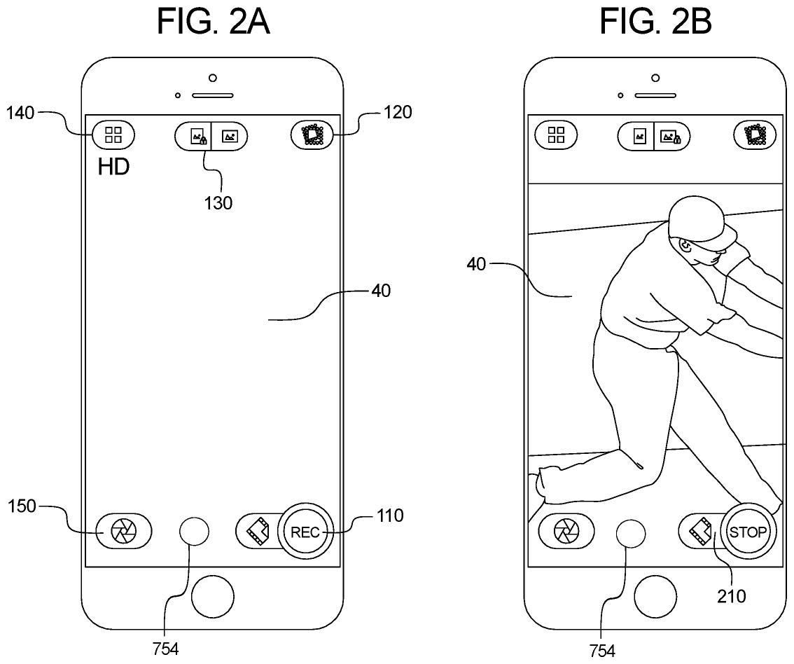

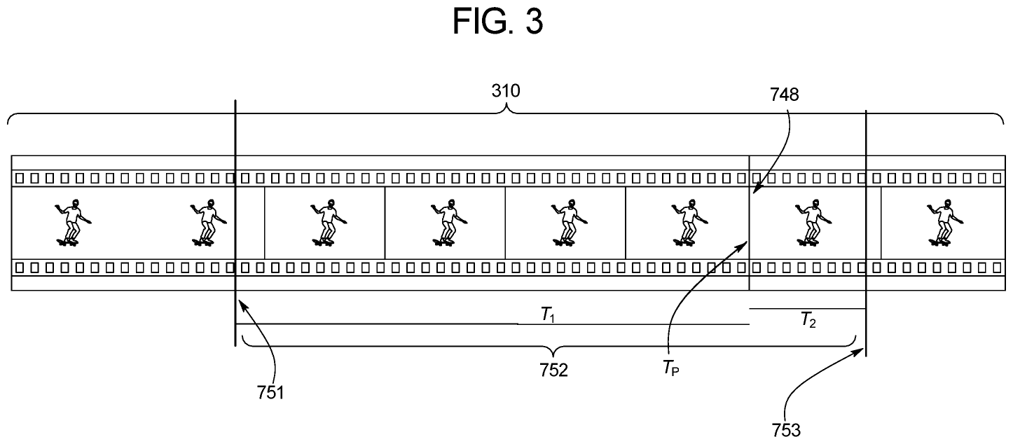

FIG. 2A is a screen illustrating the video recording system's 10 graphical user interface 40 running on a user device 30. As shown in FIG. 2A, the video recording system's 10 GUI 40 may resemble a standard smartphone camera interface with touchscreen controls 50. These controls may be located around the perimeter of the GUI 40 and include: a record button 110, access to the media gallery 120, viewing position (landscape or portrait) lock 130, sharing and settings menu 140, and the shutter 150. The GUI 40 also includes an enhanced time marker button 754, the pressing of which applies an enhanced time marker 748 (see FIG. 3) to the video 310 in order to generate a video clip 752, discussed in greater detail below. Once the application 70 is opened, the video recording system 10 may begin recording temporary video 401 into a temporary file storage arrangement 100 automatically that allows the user to capture events that occur before they press the record button 110.

FIG. 2B is a screen illustrating the video recording system's 10 graphical user interface 40 recording a video 510. As shown in FIG. 2B, when a user taps the touchscreen record button 110, the system 10 may mark a starting point 531 of a video 310. Also shown in FIG. 2B, when the user taps the record button 110 it may change into a stop recording button 210. The user may simply need to tap the button 210 again to stop actively recording video. When the user taps the button 210, the system 10 may mark an endpoint 532 of the video 310.

FIG. 3 illustrates the application of an enhanced time marker 748 to a video 310 in order to generate a video clip 752. When an enhanced time marker 748 is applied to a video 310, the enhanced time marker 748 is associated with a point in time Tₚ on the video file 310. The video recording system 10 then generates a virtual video clip 752 with a start time point 751 that is a predefined number of seconds T₁ before the point in time corresponding to the enhanced time marker 748. An end time point 753 of the video clip 752 is a predefined number of seconds T₂ after the point in time corresponding to the enhanced time marker 748. The video 310 may be a virtual video file in the temporary file storage arrangement or a recorded video on the internal memory of the user device. In some embodiments, the video 310 is a recorded video and the video clips 752 are virtual files, where the user has the option to convert the video clips 752 to recorded video files. In other embodiments, the video 310 and the video clips 752 are recorded video files automatically stored on the internal memory of the user device.

In other embodiments, the start time point 751 may be defined via voice command as the enhanced time marker 748 is applied. For example, a voice command of “enhanced time mark lasting 10 seconds” would cause an enhanced time marker 748 to be applied to the video 310 and generate a video clip 752 having a start time point 751 corresponding to the location of the enhanced time marker 748 and an end time point 753 that is 10 seconds after the start time point 751. In still other embodiments, the start and end time points 751, 753 may be provided via user input or a separater custom input device.

As shown in the embodiment illustrated in FIGS. 2A and 2B, the graphical user interface 40 used during recording may include an enhanced time marker button 754, a touchscreen control such as a side swipe, a voice command, a double tapping of the record button, or another unique interaction to apply the enhanced time markers 748 to the video file 750 during recording. In still other embodiments, the system 100 may apply an enhanced time marker 748 in response to a significant amount of screen movement or an audio increase amount, such as a cheer, with the amount of screen movement or change in audio adjustable through user settings. The user input may be also be the tapping or double tapping of a record button, a tap on a smartwatch connected to the device, or an automated outcome based on settings that are adjusted or set using artificial intelligence, such as correlating a threshold level of movement or noise with an event. In one embodiment, tapping or selecting the enhanced time marker button 754 on the graphical user interface 40 creates a video clip 752, as shown in FIG. 3.

The system 100 may collect and analyze video data collected by the user to recognize patterns within the data using machine learning and/or artificial intelligence for use in the application of enhanced time markers 748. For example, a user may capture a large amount of video footage of basketball games and recognize that video clips including basketball shots are generated with an average start time of eight seconds prior to the ball moves through the basketball hoop and an average end time of two seconds after the ball moves through the basketball hoop. During a basketball game, the user may tap the enhanced time marker button 754 or otherwise trigger the application of an enhanced time marker 748 to the video 310 during a basketball shot, and the system 100 recognizes that a basketball shot has been made and automatically generates a video clip 752 with a start time that is eight seconds before the ball moves through the hoop and an end time that is two seconds after the ball moves through the hoop. Other unlimiting examples of patterns that machine learning may be trained to recognize include complex plays within a specific sport or a specific team and audience reactions such as clapping, cheering, or silence during live events.

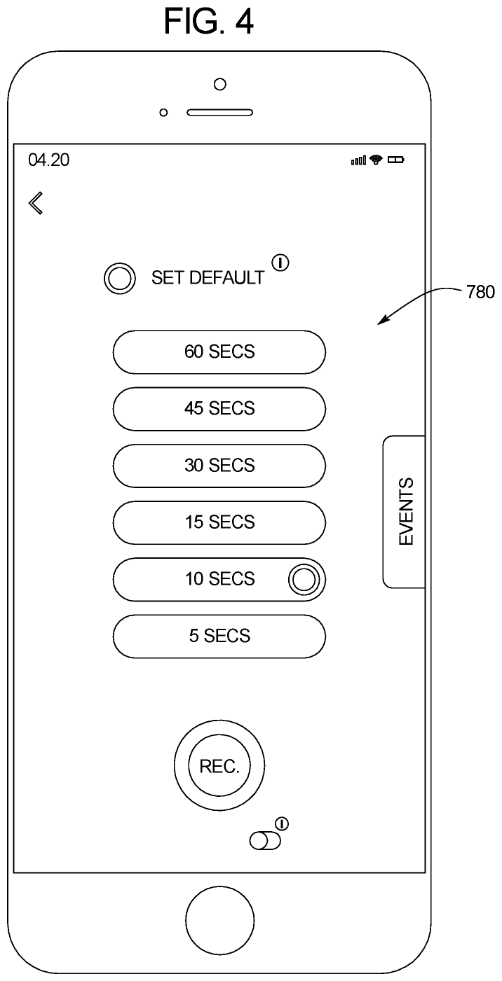

In other embodiments, tapping of the enhanced time marker button 754 on the GUI 40 of FIGS. 2A and 2B creates a video clip 752 starting ten seconds prior to the tapping of the enhanced time marker button 754 and an ending at the time that the enhanced time marker button 754 was pressed. In another embodiment, the video clip 752 starts ten seconds prior to the tapping of the enhanced time marker button 754 and an ending at the time that the enhanced time marker button 754 was pressed. In some embodiments, the user may define the start and end time points by inputting or selecting a predefined number of seconds prior to or after the time associated with the enhanced time marker in the user settings 780 as shown in the exemplary user interface of FIG. 4, by inputting the voice commands, or by adjusting the sensitivity levels of the amounts of screen movement and/or audio changes.

The video recording system 10 also allows for the use of a further user input that causes an enhanced time marker 748 to be applied to a video along with selection of a start time point of the corresponding video clip 752. For example, a vertical swipe down on the GUI 40 during recording causes the enhanced time marker 748 to be applied to the video 301. The user interface then presents a series of video frames from the video 301 at the bottom of the screen, enabling the user to select the start time point of the video clip 752. A user would use the down swipe user input to apply the enhanced time marker where the start time point is outside of the range provided for in the predefined user settings for the standard user input.

In another embodiment, a still further user input may be used to apply on-the-fly tagging of a video clip generated from an enhanced time marker 748. For example, a vertical swipe up on the GUI 40 during recording causes the enhanced time marker 748 to be applied to the video 301 and then prompts the user to select a specific color tag. When the user views the video clip 752 in the gallery 300, the video clip 752 includes an indicator that the video clip 752 is tagged.

In further embodiments, the video recording system 10 allows the user to create still photos from frames of the video clip 752. In still other embodiments, the video recording system 10 can integrate special effects such as slow motion into a video clip 752 immediately upon applying the user input that applies the enhanced time marker 748. In this example, the user interface 40 includes a slow motion button that, when selected, causes the video clip 752 to run in slow motion.

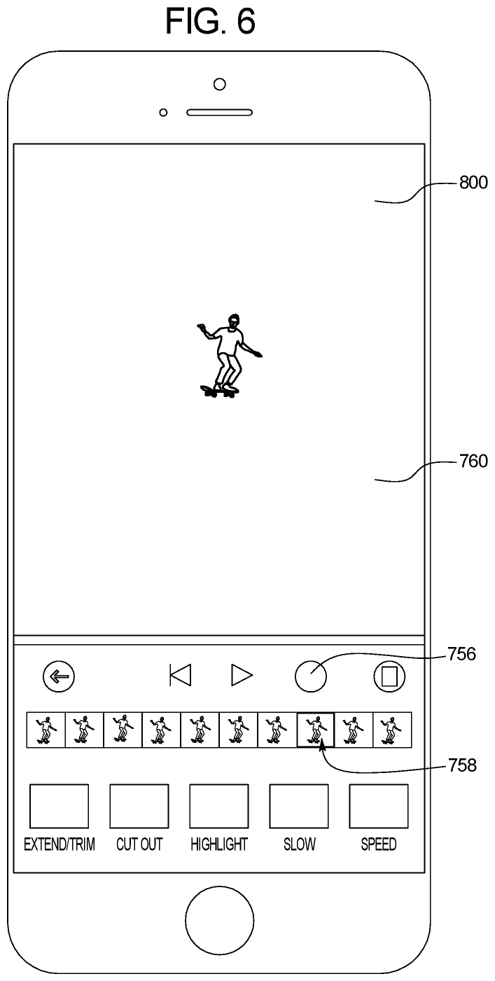

To help users easily locate desirable video portions within a longer video, users can add digital markers, like digital bookmarks, that appear on the scrub bar or thumbnail bar such as the scroll selection 758 (FIG. 6). The use of virtual video files addresses this in an enhanced way where each bookmark is interpreted as virtual video clip that appears like any other video clip within a gallery 300. Instead of moving from digital marker to digital marker on a scrub bar or thumbnail bar, users instead can view one clip after the other, completely altering the way they interact and view these ‘highlight’ segments, moving them closer to the reality of what they were aiming at when they applied the digital bookmark, which would be a special video segment or highlight reel. From a user's point of view, the use of digital bookmarks is similar to the capture of video clips while they are already recording a video, rather than adding a bookmark-type marker. Stated another way, these enhanced time markers can present themselves as virtual video clips, thereby transforming the user perspective and experience.

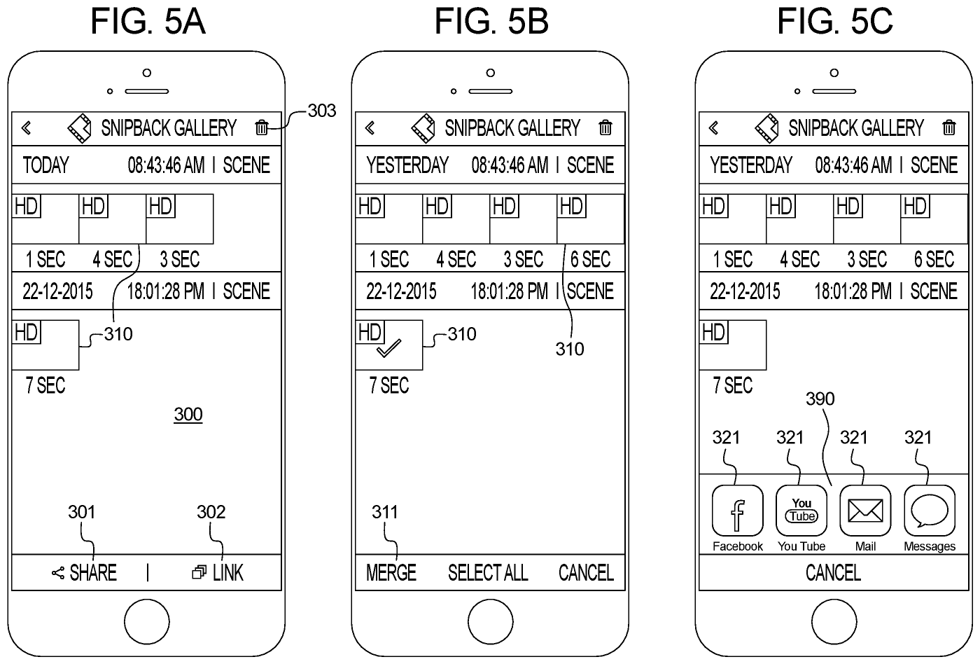

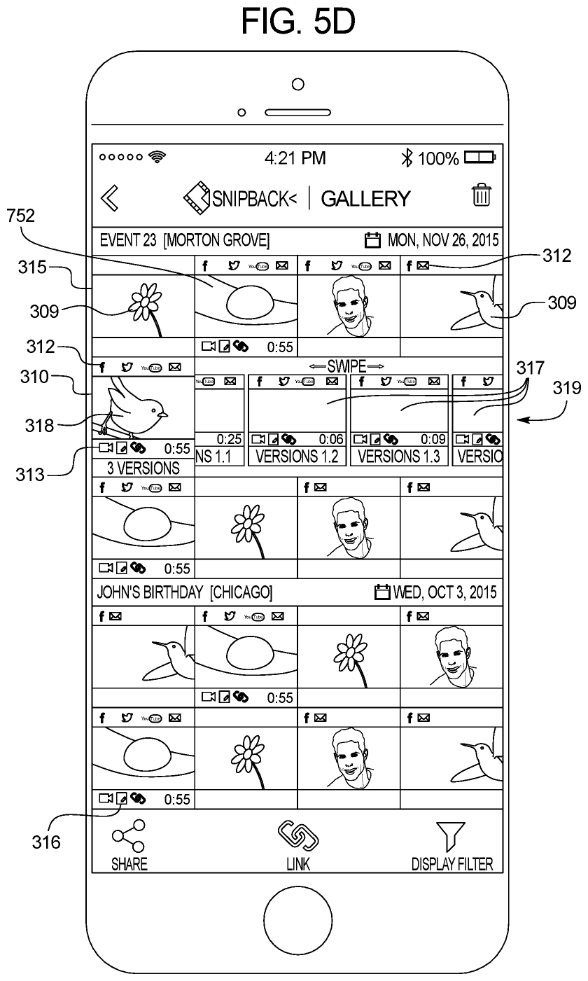

FIG. 5A is a screen illustrating the video recording system's 10 media gallery 300. As shown in FIG. 5A, when a user taps the media gallery button 120 located on the GUI 40, they may be taken to the media gallery 300. The media gallery 300 may feature all the video files 310 and video clips 752 recorded by the video recording system 10 as well as touchscreen controls including a share button 301 for posting video files 310 to social media sites, a link button 302 used for combining videos, and a delete button 303 for deleting unwanted video files 310. The media gallery 300 may read videos and photos from the system's native photo and video gallery, such as a “Photos” gallery on the IPhone. The video recording application 70 may be used to edit the videos and photos from the system's native photo and video gallery. Once saved, video files 310 and/or clips 752 generated by the standalone video recording application 70 may be moved to the system's native photo and video gallery.

FIG. 5B is a screen illustrating the capable video recording system's 10 merging video files 310. As shown in FIG. 5B, the video recording system 10 may allow a user to merge multiple video files 310 and/or clips 752 into a single video file 310, such as a highlight reel. To merge videos, the user first accesses the media gallery 300 and taps the link button 302. The system 10 may then allow the user to select those video files 310 or clips 752 they wish to merge, and then combine them by pressing the merge button 311. In an embodiment, after being merged, the video files 310 and clips 752 selected for merger may be assembled into one video file 310, containing the footage from the existing separate video files 310 that, when viewed, will play consecutively. In another embodiment, the newly created merged video file 310 may be a virtual file 317 referencing the selected video files 310.

FIG. 5C is a social media sharing screen 390 of the media gallery's 300 social media sharing feature. As shown in FIG. 5C, a user may quickly share video files 310 or clips 752 directly from the media gallery 300 by tapping the share button 301. The share button 301 may then display a set of links 321 to various video-sharing mediums (social media, email, text messaging, etc.). The user may then select from the set of links 321 presented to share the video file 310 or clip 752 with the chosen sharing medium.

FIG. 5D is another example of the media gallery 300 for videos 310, clips 752, and images 315. In the embodiment shown, thumbnails 309 for each video file 310, clip 752, or image in the gallery 300 may include sharing icons 312 displayed over the thumbnail 309 to specify if that video file 310, clip 752, or image has been shared. The sharing icons 312 may be displayed along the top of the thumbnail 309 to indicate what method or on what social network the video file 310 or clip 752 was shared, for example, the sharing icons 312 may indicate sharing via email, sharing on social networks such as Facebook®, Twitter®, YouTube®, etc. Additionally, the thumbnails 309 may include action icons 313 that show if the video has any memo notes (e.g. pending tasks) or if it is a multi link video. The action icons 313 may be displayed on bottom left of a thumbnail 309.

A thumbnail 309 of a video file 310 or clip 752 may now include a designation 316 if it is in a draft mode. In draft mode, the video file 310 or clip 752 remains editable and all changes may be made virtually, meaning no new file was created. The resulting virtual files 317 are managed via time markers that include a starting point 531 and endpoint 532 marking the location of the virtual file in the temporary file storage arrangement 400 or within another video file 310. This allows for multiple video clips to be present in the gallery 300 from the same source video.

Virtual files 317 are defined by time markers that may be interpreted by the system 10 to correctly display the virtual files 317. Each time marker may include a starting point, an endpoint, and a reference to one or more source files 317. During playback, the time markers may be used to add video (for example, in the case of merged videos 310) or remove video (for example, in the case of a trimmed video) in real-time from the source video 318. Virtual files 317 may be shared, in which case a temporary new file may be created that reflects the virtual file 317 as defined by the time markers, and then after a certain time the new file gets automatically deleted. As described herein video files 310 may be provided as actual files or virtual files 317 with reference to an actual file.

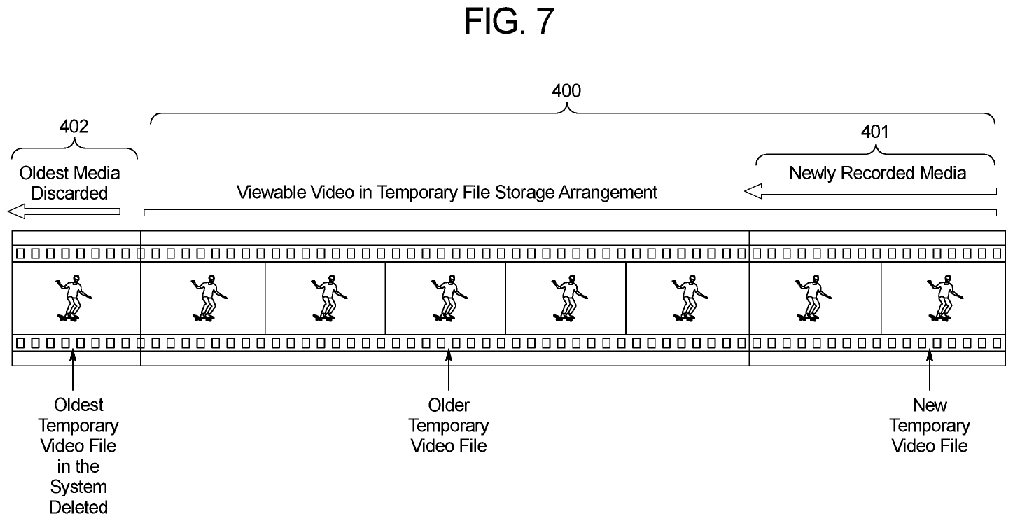

Once created, the video clip 752 is added to the gallery 300 and the user may modify the video clip 752 to the same extent that he may modify a video file 310, such as adjusting the starting and ending points as described in greater detail below with reference to FIGS. 7A and 7B. As with the virtual files 317, the video clip 752 may be a virtual file that can be converted to a recorded video. More specifically, the user can review the virtual video clip 752 and choose to convert to a recorded or real video file. Alternatively, the video clip 752 may be initially generated as a virtual file and then automatically converted to a real video. In still other embodiments, the video clip 752 may be generated as a real or recorded video file rather than a virtual video file.

Similarly, the video from which the video clip 752 is generated may be a real or recorded video file stored on the device's internal memory, a virtual video file stored in the temporary file storage arrangement on the user device, or a combination of both recorded and virtual video files.

The gallery 300 in FIG. 5D may display versions of virtual files 317 and clips 752 on their own row 319. The source video 318 may include the word “SOURCE” displayed on it, while each virtual file 317, 752 may have an associated version number. The version number of a virtual file 317 may be displayed below the virtual file 317. In the example shown, there are four versions in the second row. To the right of the source are the versions. If the gallery 300 includes more than three virtual files 317, the user may swipe in that row to scroll through the various versions. Below each virtual file 317 is the version number (e.g. 1.1, 1.2, etc.). When a user creates a virtual file 317 from an existing virtual file version, the thumbnail 309 may get smaller and another degree may be added on the versioning count (e.g. 1.1.2, 1.1.2). All these versions are virtual, so the user may create as many as he or she likes without taking up any more space. In an embodiment, the gallery 300 may include a display filter to permit the user to filter media files by type (e.g., video or photo), by tags, by source, by notes, etc.

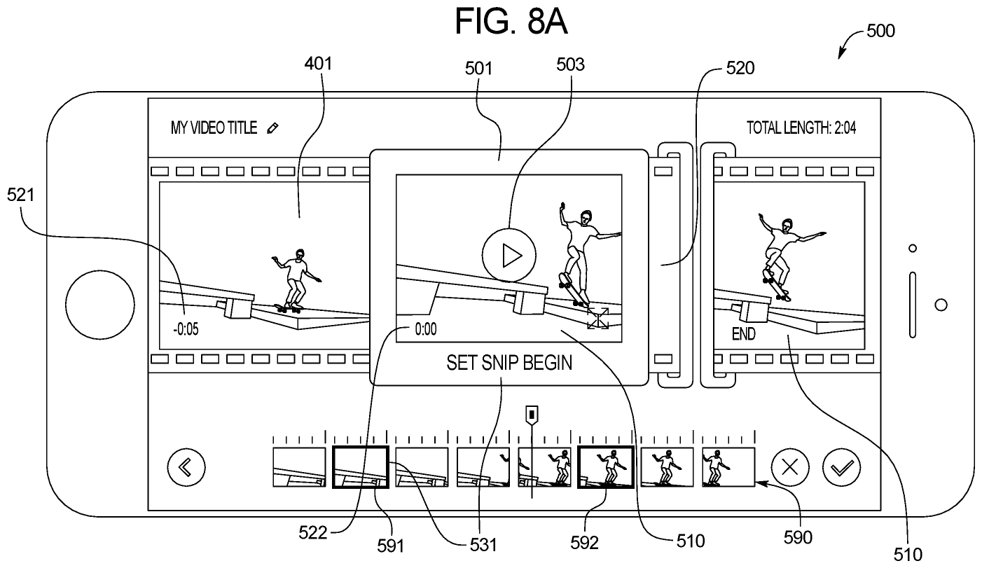

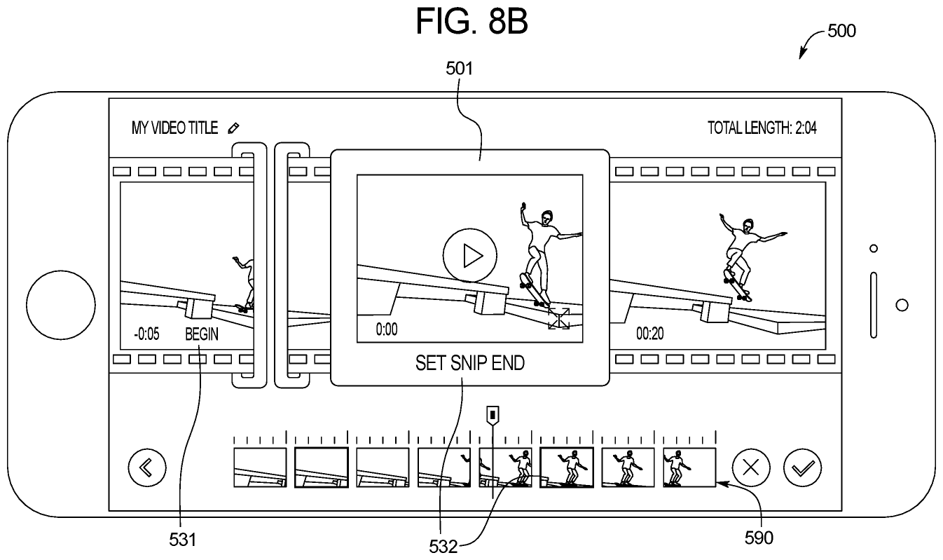

Referring to FIG. 6, the enhanced time marker 752 may also be applied to recorded videos 310 through a user interface such as the editing interface 800. The editing interface 800 includes buttons that link to editing interfaces such as the interface 500, the trimming interface 600, and the special effects interface 700 shown in FIGS. 8A-10B. The editing interface 800 includes an enhanced time marker button 756 through which the user may create a virtual video clip 752. The user may move the scroll selection 758 on a frame selection bar to the desired frame, which appears in the viewing window 760. By tapping of the enhanced time marker button 756, a video clip 752 is created, the parameters of which may be adjusted through user settings. For example, tapping of the enhanced time marker button 756 may create a video clip 752 with a starting point ten seconds prior to scroll selection frame 758 and an ending point at the scroll selection frame 758, or the video clip 752 may have a starting point ten seconds prior to scroll selection frame 758 and an ending point ten seconds after the scroll selection frame 758.

FIG. 7 is a diagram of how a temporary file storage arrangement 400 may function to store video 401. As shown in FIG. 7, a temporary file storage arrangement 400 continuously receives recorded video 401 from the camera 118 and stores the video 401 for a pre-defined time period in a temporary file storage arrangement 400. After this pre-defined period of hold time elapses, the temporary video 401 is deleted 402 to make room for newly recorded video 401. This functionality may be present in the video recording system 10 to help manage the amount of video recorded by the system 10. In other embodiments, the file storage arrangement may store video up to a certain storage amount, and progressively delete the oldest content as the storage limit is reached. In still further embodiments, the file storage arrangement may delete the content after a certain period of time. In all embodiments, this series of pre-defined video intervals, that are constantly being recorded by the system while the mobile application is running, allows the system to capture moments of video before the user actually presses the record button.

The temporary file storage arrangement 400 is useful because the video recording system 10 records video constantly without the user having to press the record button 110. Without the use of a temporary file storage arrangement 400, the amount of video 401 recorded by the system 10 would exceed storage limits. The temporary file storage arrangement 400 may enable the video recording system 10 to hold a pre-defined amount of video 401 (e.g., thirty seconds, a minute, five minutes, etc.) in separate temporary files recorded in the past that will be eventually discarded, effectively balancing storage space conservation against the risk of missing an important moment.

In an embodiment, each temporary file is thirty seconds long, and temporary files of the temporary file storage arrangement 400 are added every thirty seconds. In another embodiment, only two temporary files are kept at a time, unless included in a video 310. In some embodiments, in order to switch between files, recording is stopped for one temporary file and re-started to begin filling another temporary file. Those of skill in the art will recognize that such recording is continuous because the starting and stopping process does not introduce sizeable delays that would be noticeable to the user.

FIG. 8A is a screen illustrating the user interface 500 of the video recording system 10 adding video 401 held in a temporary file storage arrangement 400 to a recorded video clip 510. As shown in FIG. 8A, after the user captures a recorded video clip 510, the video recording system 10 may allow the user to add temporary video 401 to the beginning of the recorded video clip 510 via an interface 500. The interface 500 may display the recorded video clip 510 and temporary video 401, with the temporary video denoted with a negative time marker 521 that indicates how far in the past the temporary video 401 occurred from the time the user tapped the record button 110 and a zero time marker 522 indicating when the user tapped the record button.

Also shown in FIG. 8A, to incorporate temporary video 401 the interface 500 may allow the user to move a viewing window 501 via touchscreen controls and scroll backwards in time to the point 531 at which they wish their video 310 to begin. The viewing window 501 may display thumbnail images 502 of the recorded video 510 and temporary video 401 as the user scrolls through it. This scrolling effect may be achieved via touchscreen controls that allow a user to drag their finger horizontally along the thumbnail images 502 to the right for forward scrolling in time and to the left for backwards scrolling in time. These thumbnail images 502 may allow the user a glimpse of what is occurring at a given instant in the recorded video 510 or temporary video 401 so they can ascertain where the video file's 310 starting point 531 should be. These thumbnail images 502 may also be displayed below the viewing window 501 in a sliding bar 590 that allows the user to see entirety of recorded video 510 and temporary video 401 in a file 310. The sliding bar 590 may allow the user to select the starting point 531 and ending point 532 for a video file without the need to scroll through all the recorded video 510 and temporary video 401 using the viewing window 501.

FIG. 8B is a screen illustrating the interface 500 of the video recording system 10 setting an endpoint 532 to a video file 310. As shown in FIG. 8B, once a user sets a starting point 531 (shown in FIG. 5A) they may then select an endpoint 532 for the video 310 that may encompass both recorded video 510 and temporary video 401. The endpoint 532 may be set via the same interface 500 and scrolling touchscreen controls discussed in FIG. 8A, with the user scrolling through the recorded video 510 and temporary video 401 via touchscreen control and selecting the endpoint 532 for the video by scrolling a desired endpoint 532 into a viewing window 501. The endpoint 532 may also be selected via the sliding bar 590.

As shown in FIGS. 8A and 8B, in an embodiment, the interface 500 may include a coarse selection bar, the sliding bar 590, to permit large changes in the starting point 531 and the endpoint 532. The interface 500 may also include a fine selection bar 520 to permit fine selection of the starting point 531 and the endpoint 532 on a frame-by-frame basis. The fine selection bar 520 that may toggle between a start selection mode and an end selection mode to permit the user to select both the starting point 531 and the endpoint 532. The fine selection bar 520 may include a scrollable series of video frames to permit the user to scroll linearly along the video of the temporary file storage arrangement 400 in the forward and backward directions. In an embodiment, the user may scroll by using a right swipe gesture to move backwards in video time, and a left swipe gesture to move forwards in time. When editing the start point 531, the right swipe gesture adds video and the left swipe gesture removes video. Conversely, when editing the endpoint 532, the right swipe gesture removes video and the left swipe gesture adds video. Whenever the user updates either the starting point 531 and the endpoint 532 in either the sliding bar 590 or the fine selection bar 520, the other of the sliding bar 590 or the fine selection bar 520 may be updated to reflect the change.

The sliding bar 590 may include one or more thumbnail frames of the temporary file storage arrangement 400. The sliding bar 590 may includes a start time slider 591 and an end time slider 592. Both the start time slider 591 and the end time slider 592 may be moved along the sliding bar 590 using a drag gesture. The sliding bar 590 may include various locations along its length that the start time slider 591 and the end time slider 592 may be dragged to. In an embodiment, the locations may permit pixel-by-pixel dragging of the start time slider 591 and the end time slider 592. In another embodiment, the locations may be the thumbnail frames of the sliding bar 590. Each location along the sliding bar 590 may correspond to a time point of the video in the temporary file storage arrangement 400.

In response to the user dragging the start time slider 591 to a first location, the starting point 531 may be updated based on a time point corresponding to the first location. Additionally, the fine selection bar 520 may be placed in a start selection mode and updated to the start time point. Similarly, in response to the user dragging the end time slider 592 to a second location, the endpoint 532 may be updated based on a time point corresponding to the second location. Also, the fine selection bar 520 may be placed in an end selection mode and updated to the endpoint 532.

In the start selection mode, the starting point 531 may be updated in response to a scroll gesture on the fine selection bar 520. A central frame of the movable series of video frames may be displayed in the viewing window 501. As the user scrolls through the video frames, the video frame in the central frame may be updated as the starting point 531. Likewise, in an end selection mode, in response to a scroll gesture, the end point 532 may be updated to the central frame of the movable series of video frames. The user may then scroll through the video frames to update the endpoint 532. The viewing window 501 may include a play button 503 that the user may press to view the video file 310 as currently edited. When the user is in end selection mode, pressing the play button 503 may result in playback of a few seconds before the endpoint 532. For example, in an embodiment, the final three seconds are played back when pressing the play button 503 in end selection mode.

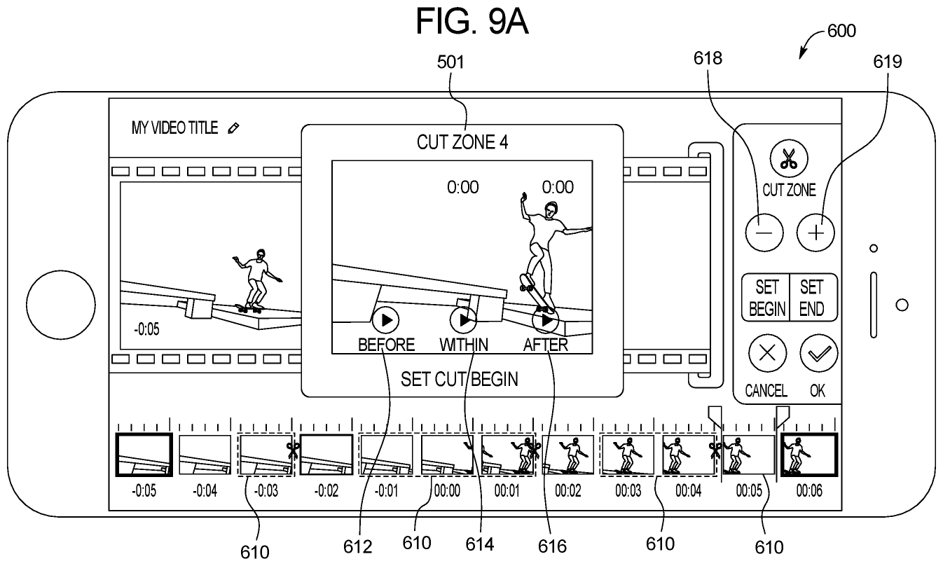

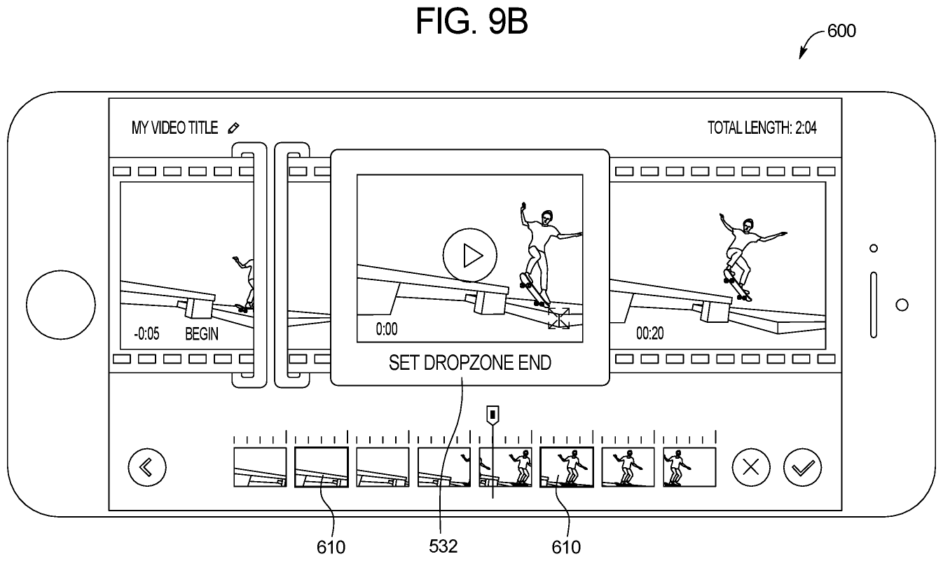

FIG. 9A is a screen illustrating the trimming interface 600 of the video recording system 10 cutting out a segment 610 of a video file 310. As shown in FIG. 9A, the video recording system 10 can remove segments 610 of video file 310 to make the video file 310 more size efficient. To achieve this shortened state, the video recording system 10 may utilize a video trimming interface 600 that is similar in design to the interface 500 discussed in FIGS. 8A and 8B. The trimming interface 600 may feature touchscreen controls that allow the user to scroll through the entirety of a video file 310 while viewing what is occurring in the video file 310 via a viewing window 501. The user may click a segment 610 to edit that segment. When editing a segment 610, the user may click a before button 612 to play the video file 310 just before the segment 610. Similarly, the user may click an after button 616 to play the video file just after the segment 610. The user may also press a within button 614 to play the video of the segment 610 that will be removed from the video file 310. Further shown in FIG. 9A, when editing out a segment 610 of a video file 310, the user first selects a starting point 531 for the portion of the video file 310 to be removed. If the user decides to add another segment 610 to be removed, the user may click an add segment button 619, and if the user decides to remove a segment 610 (that is, keep the segment 610), the user may click a remove segment button 618.

FIG. 9B is a screen illustrating the trimming interface 600 of the video recording system 10 setting an endpoint 532 when removing a segment 610 of a video file 310. As shown in FIG. 9B, the video recording system may utilize a trimming interface 600. This interface 600 may feature touchscreen controls that allow the user to scroll through the entirety of a video file 310 and view what is occurring in the video file 310 via a viewing window 501. Further shown in FIG. 9B, when editing out a segment 610 of a video file 310, after the user selects a starting point 531 for the portion of the video file 310 to be edited out (shown in FIG. 9A), the user may then select an endpoint 532. Once the endpoint 532 is selected, the system 10 may remove the portion indicated from the video file 310.

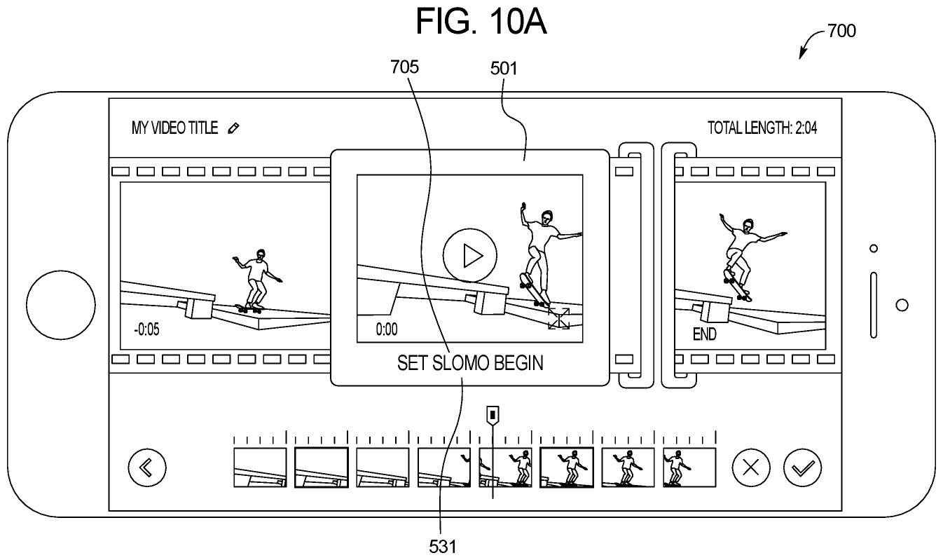

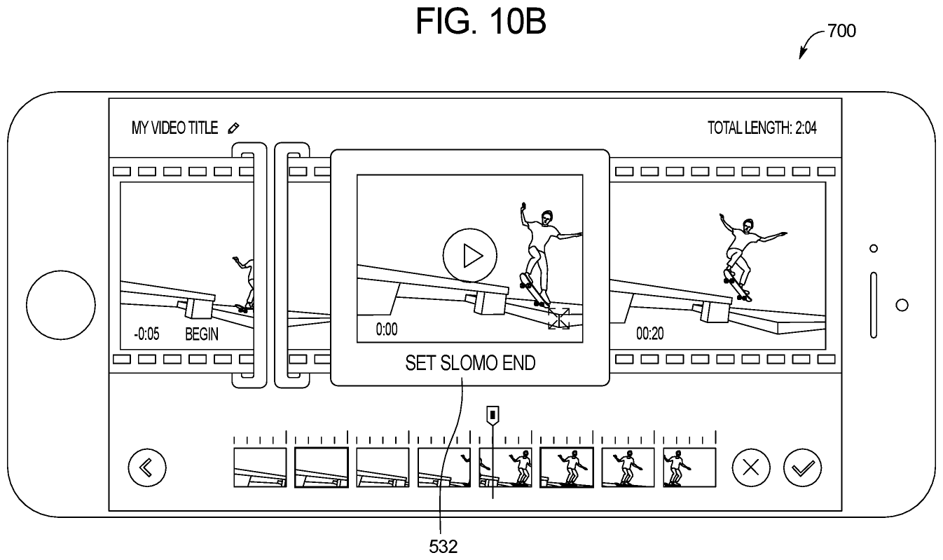

FIG. 10A screen illustrating the special effects interface 700 of the video recording system 10 adding a special effect 705 to a video file 310 or video clip 752. As shown in FIG. 10A, the video recording system 10 may utilize a special effects interface 700, similar to the touchscreen interfaces discussed in figures five and six to also add special effects 705 to a video file 310. The special effect 705 being added in FIG. 10A is a slow motion effect, but other effects such as fast forward and music 706 may be added to a video file 310 utilizing the same interface 700. To add an effect 705 or music 706, the user may first select a starting point 531 for the effect 705 or music 706 to begin via a viewing window 501. In other embodiments, the special effects interface 700 may additionally include a before button 612, an after button 616 and a within button 614 as discussed with respect to FIG. 9A.

FIG. 10B is a screen illustrating special effects interface 700 of the video recording system 10 setting an endpoint 532 for a special effect 705. As shown in FIG. 10B, the video recording system 10 may be used to add special effects or music to a video file 310. To do so, a user may first select a starting point 532 for the effect 705 or music 706 to begin via a viewing window 501 (discussed in FIG. 10A) and then select an endpoint 532 for the effect 705 or music 706 via the effects interface 700.

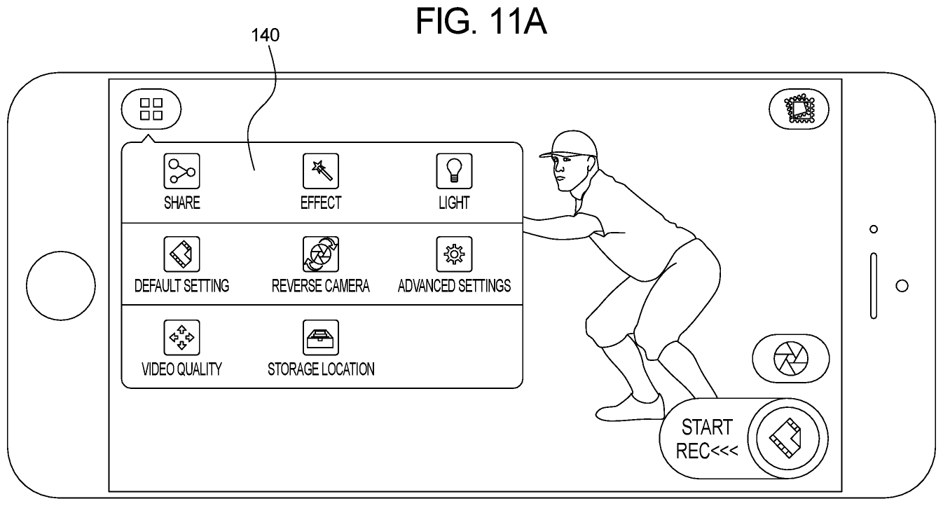

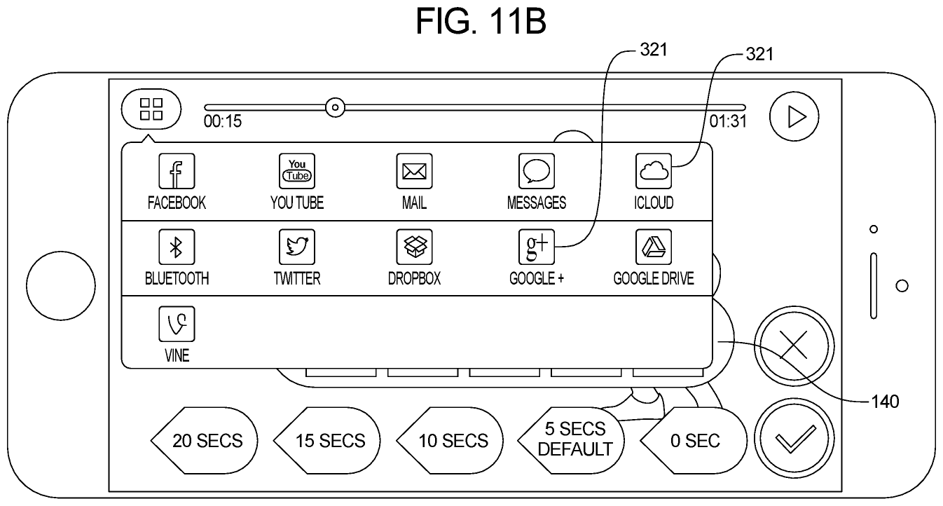

FIG. 11A is a screen illustrating the sharing and settings menu 140. As shown in FIG. 11A, the sharing and settings menu 140 may feature access to sharing options, special effects, camera and application settings, and storage options.

FIG. 11B is a screen illustrating the sharing options displayed by the sharing and settings menu 140. As shown in FIG. 11B, when a user selects to share a video from the menu 140 they are provided with links 321 to numerous different sharing mediums including email, social media, and cloud storage services. Also, as shown in FIG. 11B, in some embodiments, when selecting a starting point 531, the user may select from various preset amounts, such as five seconds, ten seconds, fifteen seconds, etc.

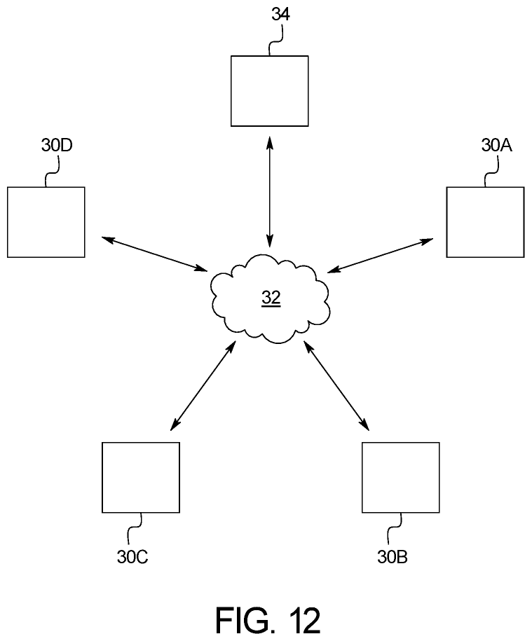

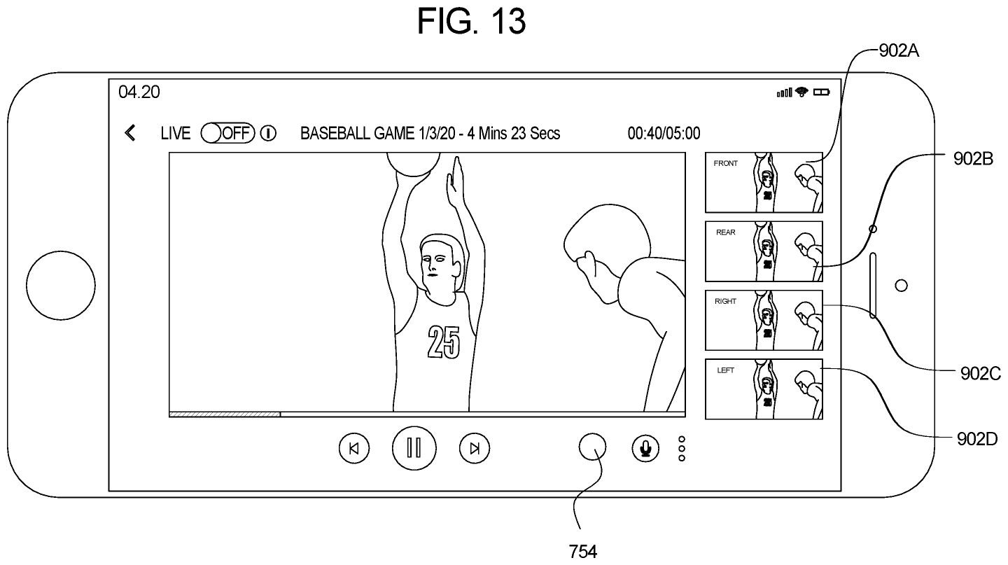

In a further embodiment illustrated in FIGS. 12 and 13, the video recording system 10 allows for communication within a network of devices 30, permitting video files 310, 317, 752 to be generated from multiple video feeds, each video feed being generated by a device 30A-30D. In one example, an entity or organization may position four handheld devices 30A-30D such as tablets around a basketball court in order to capture four different perspectives of a game. The devices 30A-30D communicate through a network 32 and may store files on a cloud server or other remote database 34 or other storage. The network 32 may include any number of devices 30, and may be used in any type of environment such as sporting events, amusement park rides, or music concerts. Each device 30A-30D may incorporate the features described in references to FIGS. 2A-10.

The network of user devices 30 may be composed of recorder user devices and controller user devices. Each recorder device 30A-30D captures a respective video feed, either in a traditional permanent file storage arrangement or in a temporary file storage arrangement, captured in whole or in fragments, and may have a user interface through which the captured video feed can be viewed. Through the video recording system 10 on each controller device, coaches and audience members can apply enhanced time markers to one or more of the video feeds from recorder devices 30A-30D. Some devices may serve as both a recorder and controller device.

Each recorder device 30A-30D continuously receives recorded video 401 from the camera of the respective device and stores the video 401 for a pre-defined period of time in a temporary file storage arrangement 400 or as a real or recorded video file on the respective device 30A-30D and/or the remote database 34. Each device 30 can access the video files 401, 750 of other devices 30 through the gallery 300 on the respective device or through a shared folder on the remote database 34. In one embodiment where the video 401 is stored locally on the respective device 30A-30D, the galleries 300 of devices 30A-30D may sync to the other devices 30A-30D. The system 100 may allow the owner of the networked devices 30A-30D to provide select users access to the video.

During recording, voice commands may be used to start and stop recording as well as to apply enhanced time markers or tags during recording. Voice commands may be used to apply an enhanced time marker 748 to a video feed 401, 750 on a specific device and to tag the enhanced time marker 748 with a specific player or a basketball move or play. Such user input may be provided through the controller devices and/or the recorder devices. A person stationed at each device 30 may also tap or select the enhanced time marker button 754 on the graphical user interface 40 to utilize enhanced time markers 748 within a video file 401, 750. The enhanced time markers may also be applied to the video feed 401, 750 based on screen activity, such as a basketball shot being made, or a change in audio volume, such as a crowd cheering or buzzer sounded.

In one example play, a player intercepts a pass between players on the opposing team and sprints down the court, scoring two points with a lay-up. A first device is located near the point of interception and a second device is located near the player's basketball net. The user, such as the coach, provides a first voice command to instruct the first device to apply a first enhanced time marker associated with the player to the video file. The video recording system 10 then creates a 10-second video clip having a starting point at ten second prior to the first voice command and an ending point at the time of the first voice command. The video file is also tagged with the player's name. Moments later, the coach provides a second voice command to instruct the second device to apply a second enhanced time marker associated with the player to its video file. The video recording system 10 then creates a second 10-second video clip having a starting point at ten second prior to the second voice command and an ending point at the time of the second voice command, tagging the second video file with the player's name. The coach can also tag each video clip by move, such as interception, pass, or layup.

In another embodiment, users in the audience view the video feeds 902A-902D from the devices 30A-30D, respectively, through the mobile application on their user devices through the user interface 900 shown in FIG. 13. A parent may select a video feed 902A-902D, which is featured in the main display area, and then capture video clip of the displayed feed by tapping the enhanced time marker button 754 on their user device. Based on the user settings, a video clip 752 having a pre-defined length with start and end time points dependent on the time associated with the enhanced time marker is generated.

In some embodiments, the system 10 may transfer all video clips 752 associated with enhanced time markers 748 related to a singular point or specific duration in time from remote recorders to a shared drive or remote database. The owner of the system 10 may have a large number of video files associated with a singular point, likely spanning well before and after a critical point in the video, such as the time leading up to a three-point shot. In some cases, the videos 401, 750 are virtual files and are automatically deleted unless selected by the user to be converted to a real file.

In other embodiments, users in the audience viewing the video 902A-902D from the devices 30A-30D through the mobile app on their user devices may create local video files by tapping the enhanced time marker button 754 on the user devices. After the game, the parent can review the video files (virtual or real) of the different perspectives and decide which video files to keep. In yet another embodiment, an audience member can record video in a traditional manner from their vantage point using their user device. After completing their recording the system can automatically generate an enhanced time marker that corresponds with the start time and end time of the captured video, and then subsequently request the necessary source video from the first through fourth recorder devices in order to collect additional, fully synched videos from additional vantage points provided by the available recorder devices. It should be noted that in one potential embodiment the application of an enhanced time marker may be initiated via the user interface in a most familiar manner by what appears to the user as a traditional record and stop recording button. In yet another iteration, an enhanced time marker may be applied by a button that's labeled “capture past 30 seconds of video”. In one embodiment, to ensure optimal performance of the system, an initialization event of all participating devices, both recorders and controllers, should take place to synch the clocks of all devices to ensure correct association of time markers associated with enhanced time markers are correctly associated with the correct video segments of source video file(s).

After the game ends, the coach can meet with the team immediately to review video files 310, 317 or clips 752. The video files 310, 317 and clips 752 recorded by all four devices 30A-30D may be collected in a single folder in the media gallery 300. The coach may sort video files and clips in the gallery 300 according to tags, such as by player name or by move. The video files 310, 317, 752 from each device 30A-30D may be also edited using any of the features described herein in order to create shorter video files. For example, a 2-hour video file created by the third device may be edited to create 150 video clips, each lasting a few seconds long. The video clips 317, 752 may be tagged by player, by move, or by play. The video clips 317, 752 may be saved as actual files, while the 2-hour virtual video file may be deleted.

The video recording system 10 can also merge video clips 752 by tag and/or time into a single video file. For example, the coach may provide a voice command to merge all video clips 752 tagged by player name so that the team can view a single merged video to see a player's performance throughout the game. The coach could also merge all video clips tagged according to moves, so that the team can review all interceptions or passes, etc., throughout the game in a single video. The coach may also merge video clips 752 by selecting the link button 302 on the media gallery 300 and tapping the clips to merge.

In a still further embodiment, the network of additional devices 30E-30K allows for users to record virtual video file 401 based on the video feeds 902A-902D. A networked device 30E provides a live video file 401 to a shared folder in the media gallery 300, which is accessible by networked devices 30F-30K as well. Viewers of devices 30F-30K may view the video feed 401 and tap the enhanced time marker button 754 on their respective GUI 40 to create a video clip 752, which they may convert to a recorded video file. For example, four devices 30A-30D may be positioned about the basketball court as described in reference to the example above. Journalists may also have access to the live video feeds 401 through devices 30G-30K and can generate a ten-second clip 752 for immediate release.

Within the network-based multiuser recording system of many recorders and controllers user devices, the ability to reduce load on recorder devices and distribute video processing load is valuable. In one embodiment, the recorder devices capture the video feed in fragments of predefined or dynamically calculated lengths of time via successive stop recording and start recording events (“stop start events”), which then can be provided to controller applications on the controller devices over the network. When a controller device applies an enhanced time marker, the video recording system can determine which file fragments are needed to fulfill the requirements of the enhanced time marker, and then request only the necessary file fragments from the relevant recorder devices in order to generate the video clip 752.

Once the controller device receives the file fragment(s) from the recorder device, the controller device generates the video and presents the video in virtual form by use of the file fragment(s), time marker information, and a specialized video player. Through the controller device, the user can easily alter the desired start point and end point associated with the enhanced time marker and preview their desired video in virtual form, and if so desired convert the file from a virtual video to a real video, all the processing of which would take place on the controller device (not the recorder device). Alternatively, once the file fragment(s) are received by the controller device, the controller device can automatically generate the desired video with the use of the enhanced time marker(s) and source video fragment(s), the processing of which would take place on the controller device.

Referring back to FIG. 2, the user device 30 may include a memory interface 102, controllers 103, such as one or more data processors, image processors and/or central processors, and a peripherals interface 106. The memory interface 102, the one or more controllers 103 and/or the peripherals interface 106 can be separate components or can be integrated in one or more integrated circuits. The various components in the user device 30 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 163, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 30 is intended to operate. For example, the user device 30 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the user device 30 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 138. The memory 138 can include high-speed random access memory and/or non-volatile memory, such as one or more magnetic disk storage devices, one or more optical storage devices, and/or flash memory (e.g., NAND, NOR). The memory 138 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the user device 30 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the user device 30 may be implemented in hardware and/or in software, including in one or more signal processing and/or application specific integrated circuits. Accordingly, the user device 30, as shown in FIG. 2, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the user device 30. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as a PC-type implementation, those skilled in the art will recognize that the one or more controllers 103 also encompasses systems such as host computers, servers, workstations, network terminals, and the like. Further one or more controllers 103 may be embodied in a user device 30, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

It should be noted that various changes and modifications to the presently preferred embodiments described herein will be apparent to those skilled in the art. Such changes and modifications may be made without departing from the spirit and scope of the present invention and without diminishing its attendant advantage.

1. A video recording system comprising:
a camera sensor;
a controller in communication with the camera sensor;
a memory in communication with the controller, the memory including a video recording application that, when executed by the controller, cause the controller to:
store video from the camera sensor;
receive a user input to associate an enhanced time marker in the video; and
generate a video clip from a subset of the stored video, the video clip beginning at a video frame associated with a start time point and ending at a video frame associated with an end time point, wherein the start and end time points are dependent on the time point associated with the enhanced time marker.

2. The video recording system of claim 1, wherein the step of storing video from the camera sensor comprises the step of:
continuously storing video in a temporary or permanent file storage arrangement from the camera sensor.

3. The video recording system of claim 1, wherein the controller receives a plurality of user inputs to associate a plurality of enhanced time markers in the video, each user input associating a respective enhanced time marker, and wherein the controller is configured to generate a plurality of video clips from the subset of stored video.

4. The video recording system of claim 1, wherein the controller receives a first user input and a second user input associated with a first enhanced time marker and a second enhanced time marker, respectively, and wherein the video clip begins at a video frame associated with a start time point dependent on the time point associated with the first enhanced time marker and ends at a video frame associated with an end time point, wherein the end time point dependent on the time point associated with the second enhanced time marker.

5. The video recording system of claim 1, wherein the step of receiving a user input comprises the steps of:
provide a recording user interface including an enhanced time marker button; and
receive a user input via the enhanced time marker button, wherein the input associates an enhanced time marker with a time point in the video.

6. The video recording system of claim 1, wherein the step of receiving a user input comprises the step of receiving a voice command to associate an enhanced time marker with a time point in the video.

7. The video recording system of claim 1, wherein the start time point is a predetermined number of seconds prior to the time point associated with the enhanced time marker.

8. The video recording system of claim 1, wherein the end time point is one of a predetermined number of seconds after the time point associated with the enhanced time marker and the time point associated with the enhanced time marker.

9. The video recording system of claim 1, further comprising a database including user settings, wherein the user settings include parameters associated with the enhanced time marker button.

10. The video recording system of claim 9, wherein the parameters include defining a predetermined number of seconds prior to the time point associated with the enhanced time marker as the start time point.

11. The video recording system of claim 9, wherein the parameters include defining a dynamically generated number of seconds prior to the time point associated with the enhanced time marker as the start time point.

12. The video recording system of claim 11, wherein the dynamically generated number of seconds is based on artificial intelligence.

13. The video recording system of claim 9, wherein the parameters include defining a predetermined number of seconds after the time point associated with the enhanced time marker as the end time point.

14. The video recording system of claim 9, wherein the parameters include defining a dynamically generated number of seconds after the time point associated with the enhanced time marker as the end time point.

15. The video recording system of claim 14, wherein the dynamically generated number of seconds is based on artificial intelligence.

16. The video recording system of claim 1, further comprising a user device associated with the camera sensor, the controller, and the memory.

17. The video recording system of claim 16, further comprising a remote database, wherein the video is stored on the remote database.

18. The video recording system of claim 17, wherein the remote database is a memory of a further user device.

19. The video recording system of claim 17, wherein the video is stored in a temporary file storage arrangement on the remote database.

20. The video recording system of claim 17, further comprising a further device including:
a further controller in communication with the remote database; and
a further memory in communication with the further controller, the further memory including a further video recording application that, when executed by the controller, cause the further controller to:
provide a media gallery user interface including the temporary file storage arrangement from the remote database.

21. The video recording system of claim 20, wherein the further device includes a further camera sensor in communication with the further controller, and wherein the video recording application further causes the further controller to:
store a further video from the further camera sensor;
receive a further user input to associate a further enhanced time marker with a further time point in the further video; and
generate a further video clip from a further subset of the further video, the further video clip beginning at a video frame associated with a further start time point and ending at a video frame associated with a further end time point, wherein the further start and further end time points are dependent on the further time point associated with the further enhanced time marker.

22. The video recording system of claim 21, wherein the step of storing the further video from the further camera sensor comprises the step of:
continuously storing the further video in a further temporary file storage arrangement in one file or as a combination of file segments from the further camera sensor.

23. The video recording system of claim 21, wherein the further temporary file storage arrangement is stored on the remote database as a single file or as a combination of file segments.

24. The video recording system of claim 21, wherein the video recording application on the user device causes the controller to:
provide a further media gallery user interface including the further video from the remote database.
